(19) United States
(12) Patent Application Publication
(10) Pub. No.: US 2026/0154836 A1
(43) Pub. Date: Jun. 4, 2026

(54) APPARATUS FOR TIGHTENING FASTENER AND CONTROL METHOD THEREOF

(71) Applicant: SK ON CO., LTD., Seoul (KR)

(72) Inventors: Dong Hyun LEE, Daejeon (KR); Min Jeong HONG, Daejeon (KR); Jae Hun KIM, Daejeon (KR); Yoon Sung OH, Daejeon (KR)

(21) Appl. No.: 19/435,787

(22) Filed: Dec. 30, 2025

Related U.S. Application Data
(63) Continuation of application No. PCT/KR2024/002628, filed on Feb. 29, 2024.

(30) Foreign Application Priority Data
Jun. 30, 2023 (KR) 10-2023-0085056
Oct. 16, 2023 (KR) 10-2023-0137409

(51) Int. Cl. G06T 7/60; B23P 19/06

(52) U.S. Cl. CPC G06T 7/60; B23P 19/06; G06T 2207/30164

(57) ABSTRACT

The embodiments of the present disclosure relate to an apparatus for tightening a fastener and a control method thereof. An apparatus for tightening a fastener according to an embodiment of the present disclosure may include a tightening tool configured to engage a fastener and tighten the fastener, a memory storing an artificial intelligence model; a camera that captures an image of a tightening region where the fastener is to be tightened; and a processor that uses the artificial intelligence model to estimate information about the tightening region from the image captured by the camera, determines, based on the estimated information, whether a specified reference tightening condition is satisfied, and in response to the reference tightening condition being satisfied, controls the tightening tool to tighten the fastener in the tightening region. Accordingly, the embodiments can improve the tightening accuracy, work efficiency or both of the fastener tightening apparatus.

### CROSS-REFERENCES TO RELATED APPLICATION

The present application is a Bypass Continuation of International Patent Application No. PCT/KR2024/002628 Application filed on Feb. 29, 2024, which claims priority under 35 U.S.C. § 119(a) to Korean Patent Application No. 10-2023-0085056 filed on Jun. 30, 2023, and Korean Patent Application No. 10-2023-0137409 filed on Oct. 16, 2023, which are all incorporated herein by reference in their entirety.

### BACKGROUND

### 1. Field of the Invention

The embodiments of the present disclosure relate to an apparatus for tightening a fastener and a control method thereof.

### 2. Description of the Related Art

A secondary battery is a battery that can be repeatedly charged and discharged. With the development of the information communication and display industries, it is widely applied as a power source for portable electronic communication devices such as camcorders, mobile phones, tablet PCs (personal computers), and notebook PCs. Furthermore, recently, battery packs including secondary batteries have been developed for use as a power source for eco-friendly vehicles such as electric vehicles.

In a secondary battery, to protect the secondary battery module or a vehicle body from vibration and impact, various constituent components (e.g., materials such as an upper case, a lower case, a busbar, an endplate, etc.) may be tightened with screws or bolts. Each constituent component may be a material with low rigidity, such as a thin aluminum plate manufactured by bending or a plastic material for insulation.

In a secondary battery, screws or bolts may be tightened via an automatic tightening apparatus (e.g., a nut runner). For example, the materials to be tightened are constrained by jigs or datum pins, and the automatic tightening apparatus moves to the position of a tightening hole and sequentially tightens the screws or bolts.

However, due to various causes (e.g., accumulated tolerance during assembly, warping of a flexible material due to sequential tightening, varying tolerances of each material according to a LOT, etc.), a case may occur where the center point of the tightening hole of the material and the center point of the automatic tightening apparatus do not align. In such a case, a tightening failure (e.g., a screw or bolt is inserted obliquely) and/or component damage (e.g., damage to a thread, expansion of the tightening hole, damage to a bit of the tightening apparatus, etc.) may occur.

### SUMMARY

An embodiment of the present disclosure provides an apparatus for tightening a fastener with improved tightening accuracy, and a control method thereof.

Another embodiment of the present disclosure provides an apparatus for tightening a fastener with improved work efficiency, and a control method thereof.

According to an embodiment, there may be provided an apparatus for tightening a fastener, including a tightening tool configured to engage a fastener and tighten the fastener; a memory storing an artificial intelligence model; a camera that captures an image of a tightening region where the fastener is to be tightened; and a processor operatively coupled to the tightening tool, the memory, and the camera, wherein the processor is programmed to: estimate, using the artificial intelligence model, information about the tightening region from the image captured by the camera, determine, based on the estimated information, whether a specified reference tightening condition is satisfied, and in response to the reference tightening condition being satisfied, control the tightening tool to tighten the fastener in the tightening region.

In some non-limiting embodiments, the artificial intelligence model is pre-trained, and the specified reference tightening condition includes at least one of: a seating state between a first tightening member and a second tightening member disposed on the first tightening member, whether a first tightening hole formed in the first tightening member is obstructed, and a difference between a central axis of the tightening tool and a central axis of the first tightening hole.

In some non-limiting embodiments, the processor is further programmed to determine whether a correction is possible, in response to the specified reference tightening condition not being satisfied; correct, in response to a determination that the correction is possible, at least one of a position of the tightening tool, a tightening angle of the fastener, a position of the second tightening member, a seating state of the second tightening member, and a size of a second tightening hole formed in the second tightening member, to satisfy the specified reference tightening condition; and generate an alarm, in response to a determination that the correction is not possible, indicating that tightening of the fastener in the tightening region is not possible.

In some non-limiting embodiments, the processor is further programmed to: move the position of the tightening tool, in response to the difference between the central axis of the tightening tool and the central axis of the first tightening hole exceeding a specified reference value, such that the difference is within the specified reference value.

In some non-limiting embodiments the processor is further programmed to, in response to the second tightening member obstructing a portion of the first tightening hole: calculate a tightening angle based on a thickness of the second tightening member and an obstruction length of the second tightening member obstructing the first tightening hole; and control the tightening tool to tilt by the calculated tightening angle.

In some non-limiting embodiments, the apparatus further includes a machining tool; and the processor is further programmed to, in response to the second tightening member obstructing a portion of the first tightening hole: calculate an obstruction length and an obstruction direction of the second tightening member obstructing the first tightening hole; and control the machining tool to remove a portion of the second tightening member in the obstruction direction by the obstruction length.

In some non-limiting embodiments, the apparatus further includes a pressurizing tool; and the processor is further programmed to, in response to the second tightening member obstructing a portion of the first tightening hole: calculate an obstruction length and an obstruction direction of the second tightening member obstructing the first tightening hole; and control the pressurizing tool to move the second tightening member in the obstruction direction by the obstruction length.

In some non-limiting embodiments, the apparatus further includes a pressurizing tool; and the processor is further programmed to, in response to the second tightening member being seated at an incline on the first tightening member: calculate an angle of the incline of the second tightening member based on an actual diameter of the second tightening hole and a diameter of the second tightening hole calculated from the image; and control the pressurizing tool to press the second tightening member in a direction toward the first tightening member in correspondence with the calculated angle of the incline.

In some non-limiting embodiments, the processor is further programmed to, when the first tightening member includes a plurality of first tightening holes: recognize an obstruction trend based on obstruction directions for the plurality of first tightening holes; and generate an alarm, based on the recognized obstruction trend, indicating that an adjustment for the second tightening member is required.

In some non-limiting embodiments, the processor is further programmed to: generate an alarm indicating that a reset of a working environment is required, in response to the correction occurring more than or equal to a specified number of times.

In some non-limiting embodiments, the tightening tool is a nut runner and the fastener is a screw or a bolt, and the processor is further programmed to: preprocess the captured image; analyze the preprocessed image using the artificial intelligence model; recognize the tightening region based on a result of the analysis; and estimate the information about the tightening region based on a result of the recognition.

According to another embodiment, there may be provided a method for controlling a tightening apparatus, the method including capturing, using a camera, an image of a tightening region where a fastener is to be tightened; estimating, using a pre-trained artificial intelligence model, information about the tightening region from the captured image; determining, based on the estimated information, whether a specified reference tightening condition is satisfied; and in response to the specified reference tightening condition being satisfied, tightening the fastener in the tightening region using a tightening tool.

In some non-limiting embodiments, the operation of determining whether the specified reference tightening condition is satisfied includes: determining a seating state between a first tightening member and a second tightening member disposed on the first tightening member, determining whether a first tightening hole formed in the first tightening member is obstructed; and determining whether a difference between a central axis of the a tightening tool and a central axis of the first tightening hole is within a specified reference value.

In some non-limiting embodiments, the method further includes in response to the specified reference tightening condition not being satisfied, determining whether a correction is possible; and in response to a determination that the correction is not possible, generating an alarm indicating that tightening of the fastener in the tightening region is not possible, and in response to a determination that the correction is possible, correcting at least one of a position of the tightening tool, a tightening angle of the fastener, a position of the second tightening member, a seating state of the second tightening member, and a size of a second tightening hole formed in the second tightening member.

In some non-limiting embodiments, the operation of correcting includes in response to a difference between a center coordinate of the first tightening hole and a center coordinate of the tightening tool exceeding a specified reference value, moving the position of the tightening tool such that the difference is within the specified reference value.

In some non-limiting embodiments, the operation of correcting includes performing, in response to the second tightening member obstructing a portion of the first tightening hole, at least one of the following: calculating a tightening angle based on a thickness of the second tightening member and an obstruction length of the second tightening member obstructing the first tightening hole, and tilting the tightening tool by the calculated tightening angle; calculating an obstruction length and an obstruction direction of the second tightening member obstructing the first tightening hole, and, using a machining tool, removing a portion of the second tightening member in the obstruction direction by the obstruction length; and calculating an obstruction length and an obstruction direction of the second tightening member obstructing the first tightening hole, and, using a pressurizing tool, moving the second tightening member in the obstruction direction by the obstruction length.

In some non-limiting embodiments, the operation of correcting includes, in response to the second tightening member being seated at an incline on the first tightening member: calculating an angle of the incline of the second tightening member based on an actual diameter of the second tightening hole and a diameter of the second tightening hole calculated from the image; and in correspondence with the calculated angle of the incline, pressing, using a pressurizing tool, the second tightening member in a direction toward the first tightening member.

In some non-limiting embodiments, the method further includes at least one of: when the first tightening member includes a plurality of first tightening holes, recognizing an obstruction trend based on obstruction directions for the plurality of first tightening holes and, based on the recognized obstruction trend, generating an alarm indicating that an adjustment for the second tightening member is required; and generating an alarm indicating that a reset of a working environment is required, in response to the correction occurring more than or equal to a specified number of times.

In some non-limiting embodiments, the method further includes preprocessing the captured image; and the operation of estimating information about the tightening region includes analyzing the preprocessed image using the artificial intelligence model; recognizing the tightening region based on a result of the analysis; and estimating the information about the tightening region based on a result of the recognition.

In some embodiments, the tightening tool may be a nut runner and the fastener may be a screw or a bolt.

According to an embodiment, there may be provided an apparatus for tightening a fastener, including a tightening tool configured to engage a fastener and tighten the fastener to a tightening region including at least two components that are tightened via the fastener, a position/tilting controller operatively coupled to the tightening tool for changing the position, angle, or both of the tightening tool; a memory storing an artificial intelligence model; a camera that captures an image of the tightening region where the fastener is to be tightened; and a processor operatively coupled to the tightening tool, the memory, the camera, and the position/tilting controller wherein the processor is configured to: use the artificial intelligence model to estimate information about the tightening region from the image captured by the camera, and use the information to control the position/tilting controller to change the position, tilt, or both of the tightening tool, and to control the tightening tool to tighten the fastener in the tightening region.

According to an embodiment of the present disclosure, the tightening accuracy of the apparatus for tightening a fastener can be improved. For example, the embodiments of the present disclosure can improve tightening accuracy by proceeding with tightening after substantially aligning (e.g., having a difference within a specified range) the center of a tightening hole (e.g., a bolt hole or a screw hole) with the center of a fastener (e.g., a bolt, a screw, an anchor, a rivet, etc.). Furthermore, as the tightening accuracy is improved, the embodiments can prevent various types of damage (e.g., damage to the thread of a bolt or screw, damage to the thread of the tightening hole, expansion of the tightening hole, and/or damage to a bit of the fastener tightening apparatus) that may occur during incorrect tightening due to center misalignment.

In addition, according to an embodiment of the present disclosure, the work efficiency (or efficiency) of the fastener tightening apparatus can be improved. For example, the embodiments can improve the efficiency of the fastener tightening apparatus by tightening the fastener after adjusting the tightening angle of the fastener and/or correcting the state of the tightening region (e.g., moving the position of the case, adjusting the seating state of the case, or machining the size of the case hole) when it is somewhat difficult to tighten the fastener in the tightening hole (e.g., when a portion of the tightening hole is obstructed by a case, when a case (second tightening member) is not normally seated on a tightening member (first tightening member)).

The embodiments of the present disclosure can minimize rework due to incorrect tightening and/or work stoppage due to a situation where tightening is not possible. Furthermore, the embodiments can reduce the downtime of the fastener tightening apparatus, improve quality, and improve the defect scrap rate. In addition, the embodiments can improve production performance and/or production yield.

### BRIEF DESCRIPTION OF THE DRAWINGS

The above and other objects, features and other advantages of the embodiments of the present disclosure will be more clearly understood from the following detailed description taken in conjunction with the accompanying drawings, in which:

FIG. 1 is a drawing schematically illustrating an apparatus for tightening a fastener according to an embodiment of the present disclosure;

FIG. 2 is a block diagram illustrating a configuration of the apparatus for tightening a fastener according to an embodiment of the present disclosure;

FIG. 3 is a flowchart illustrating a control method of the apparatus for tightening a fastener according to an embodiment of the present disclosure;

FIG. 4 is a drawing illustrating preprocessing an image according to an embodiment of the present disclosure;

FIG. 5A is a drawing illustrating a tightening region recognized from an image according to an embodiment of the present disclosure;

FIG. 5B is a drawing illustrating information about a tightening region estimated from an image according to an embodiment of the present disclosure;

FIG. 6A is a drawing illustrating correcting a position of the tightening tool according to an embodiment of the present disclosure;

FIG. 6B is a drawing illustrating correcting a tilting angle of the tightening tool according to an embodiment of the present disclosure;

FIG. 6C is a drawing illustrating correcting a tightening hole using the machining tool according to an embodiment of the present disclosure;

FIG. 6D is a drawing illustrating correcting a position of a tightening member using the pressurizing tool according to an embodiment of the present disclosure; and

FIG. 6E is a drawing illustrating correcting a seating state of a tightening member using the pressurizing tool according to an embodiment of the present disclosure.

### DETAILED DESCRIPTION

Hereinafter, the embodiments of the present disclosure will be described in detail with reference to the accompanying drawings. However, the embodiments are merely illustrative and are not limited to the specific embodiments described herein.

Although terms, such as, a first, a second, and the like are used to describe various elements, components and/or sections, these elements, components and/or sections are of course not limited by these terms. These terms are merely used to distinguish one element, component and/or section from another element, component and/or section. Therefore, the first element, first component or first section mentioned below may also be the second element, second component or second section within the technical scope of the present disclosure.

Terms used herein are for the purpose of describing particular embodiments only and are not intended to limit the scope of the present disclosure thereto. As used herein, singular forms are intended to include the plural forms as well, unless the context clearly indicates otherwise. It will be further understood that the terms “comprises” and/or “made of,” as used herein, do not preclude the presence or addition of one or more components, steps, operations and/or elements other than the mentioned component, step, operation and/or element.

Unless otherwise defined, all terms (including technical and scientific terms) used herein have the same meaning as commonly understood by one of ordinary skill in the art to which the present disclosure pertains. Terms, such as those defined in commonly used dictionaries, are not to be construed in an idealized or overly formal sense unless expressly so defined herein.

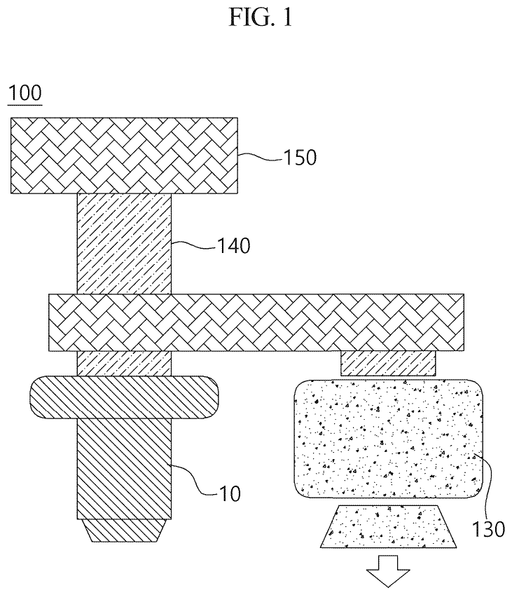

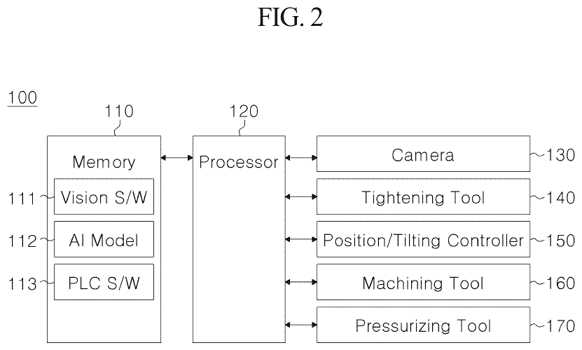

FIG. 1 is a drawing schematically illustrating an apparatus for tightening a fastener according to an embodiment of the present disclosure, and FIG. 2 is a block diagram illustrating a configuration of the apparatus for tightening a fastener according to an embodiment of the present disclosure.

Referring to FIGS. 1 and 2, a fastener tightening apparatus 100 according to an embodiment of the present disclosure can tighten a fastener 10 (e.g., a bolt, a screw, a rivet, an anchor, etc.) into a tightening hole of a tightening member (not shown). For example, the fastener tightening apparatus 100 may couple (e.g., attach) the fastener 10 to a lower end of the tightening tool 140, move the tightening tool 140 to which the fastener 10 is coupled to a position above the tightening hole, and then tighten the fastener 10 into the tightening hole by rotating the tightening tool 140. Hereinafter, for convenience of description, a case in which at least some of the components constituting a battery module are tightened with fasteners (bolts or screws) will be described.

According to an embodiment, the fastener tightening apparatus 100 may include a memory 110, a processor 120, a camera 130, a tightening tool 140, a position/tilting controller 150, a machining tool 160, and a pressurizing tool 170.

The memory 110 may store a program for controlling the tightening operation of the fastener tightening apparatus 100. Furthermore, the memory 110 may store information necessary for controlling the tightening operation of the fastener tightening apparatus 100. According to an embodiment, the memory 110 may include a vision software program 111, an artificial intelligence model 112, and a PLC software program 113.

The vision software program 111 may control the camera 130 to capture an image of the tightening region.

The artificial intelligence model 112 may preprocess the captured image and estimate information about the tightening region, such as bolt hole recognition, center point coordinates, a minimum diameter, a maximum diameter, coordinates of each endpoint of the minimum diameter, coordinates of each endpoint of the maximum diameter, etc., The artificial intelligence model 112 may be pre-trained via training data. For example, the training data may comprise a dataset of images capturing the tightening region under various conditions. This dataset can include images of normal states where the tightening hole is not obstructed, as well as images of various abnormal states, such as misalignment between tightening members, partial obstruction of a tightening hole, or improper seating of a tightening member. Furthermore, the training data may be composed of labeled data, in which information such as the center point, diameter, and boundary of the tightening hole is annotated, and/or unlabeled data. The artificial intelligence model 112 may include AI algorithms such as Mask R-CNN, YOLO, U-Net, etc. More specifically, the artificial intelligence model 112 may be pre-trained using labeled or unlabeled training data and may implement one or more computer vision algorithms, such as the Mask R-CNN, YOLO, U-Net, or other suitable deep learning architectures configured for image analysis, object detection, or segmentation. The artificial intelligence model 112 may continue to learn from new data obtained during operation of the fastener tightening apparatus.

The PLC (programmable logic controller) software program 113 may control the operation of the fastener tightening apparatus 100. For example, when a correction of a position and/or tilting angle is required based on the estimated information, the PLC software program 113 may control the position/tilting controller 150 to move the position movement and/or adjust the tilting angle of the fastener tightening apparatus 100. Furthermore, when the first tightening hole of the first tightening member is obstructed by the second tightening member, the PLC software program 113 may control the machining tool 160 to remove a portion of the second tightening member that is obstructing the first tightening hole. In addition, when the first tightening hole of the first tightening member is obstructed by the second tightening member, the PLC software program 113 may control the pressurizing tool 170 to pressurize the second tightening member that obstructs the first tightening hole to move the position of the second tightening member. In addition, when the first tightening member and the second tightening member are not normally seated, the PLC software program 113 may control the pressurizing tool 170 to pressurize the second tightening member to normally seat the second tightening member on the first tightening member.

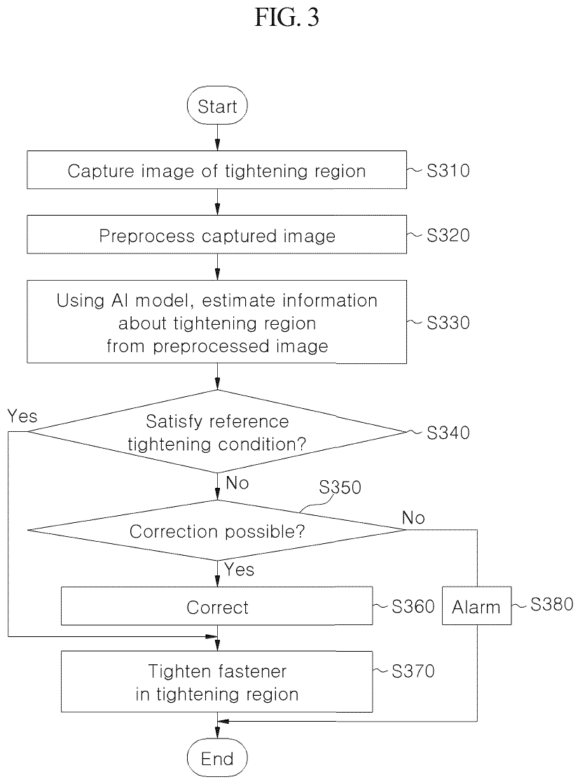

The processor 120 may control the operation of the fastener tightening apparatus 100. For example, the processor 120 may, using the artificial intelligence model 112, estimate information about the tightening region from the image captured by the camera 130, determine whether a specified reference tightening condition is satisfied based on the estimated information, and in response to the reference tightening condition being satisfied, control the tightening tool 140 to tighten the fastener 10 in the tightening region. Furthermore, when the reference tightening condition is not satisfied, the processor 120 may determine whether a correction is possible, and when the correction is possible, may perform at least one of an adjustment of the position of the tightening tool, a tightening angle of the fastener 10, or both via the position/tilting controller 150, a correction of the size of the second tightening hole formed in the second tightening member via the machining tool 160, and a correction of the position of the second tightening member, the seating state of the second tightening member, or both via the pressurizing tool 170, to satisfy the reference tightening condition. When the correction is not possible, the processor 120 may generate an alarm indicating that tightening of the fastener 10 in the tightening region is not possible. A detailed description thereof will be given later with reference to FIGS. 3 to 6E.

The camera 130 may capture an image of the tightening region where the fastener 10 is to be tightened. The camera 130 may be positioned next to the tightening tool 140.

The tightening tool 140 may tighten the fastener 10 in the tightening region. For example, the fastener 10 may be attached to or detached from one end portion of the tightening tool 140. The tightening tool 140 may rotate the attached fastener 10 to tighten the fastener 10 in an engagement region.

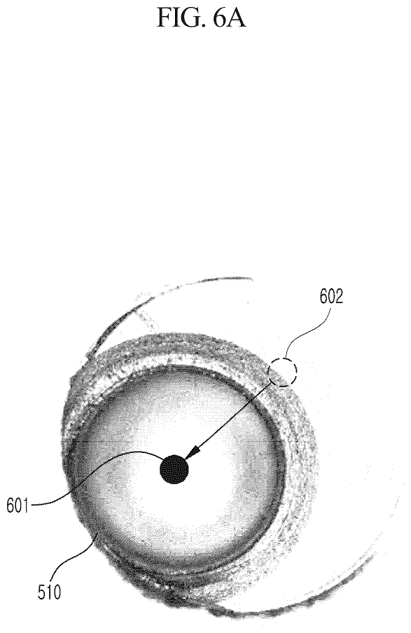

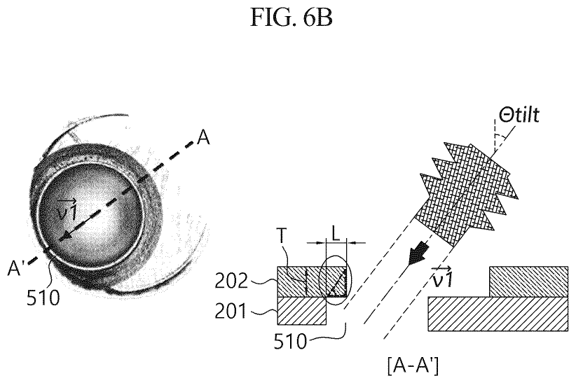

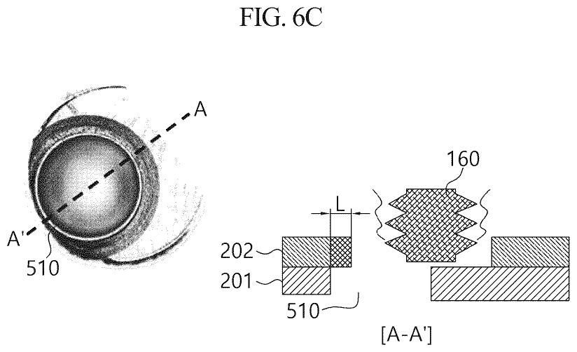

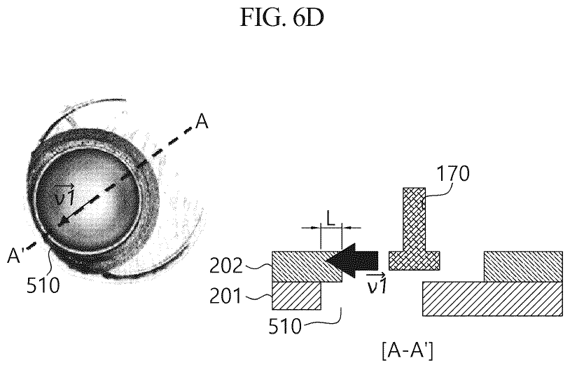

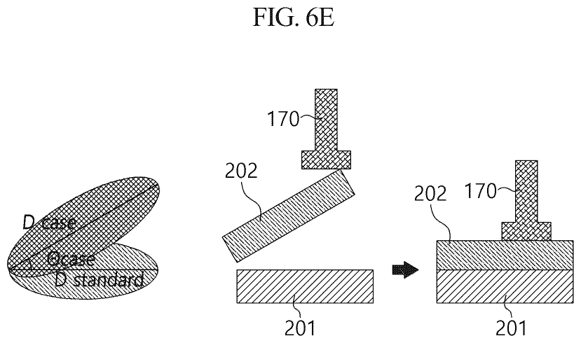

The position/tilting controller 150 may move the position of the tightening tool 140. For example, to accurately tighten the fastener 10 in the tightening region, the position/tilting controller 150 may move the position of the tightening tool 140 so that the center of the tightening hole of the tightening region and the center of the tightening tool 140 are aligned (or are within a specified reference value). A detailed description thereof will be given later with reference to FIG. 6A. In addition, the position/tilting controller 150 may tilt the tightening tool 140 within a specified range. For example, when a portion of the tightening hole of the tightening region is obstructed, the position/tilting controller 150 may tilt the tightening tool 140 by a tilting angle. A detailed description thereof will be given later with reference to FIG. 6B.

The machining tool 160 may remove a portion of a tightening member (not shown). For example, when a portion of the tightening hole of the tightening region is obstructed, the machining tool 160 may remove the tightening member that is obstructing the tightening hole. The machining tool 160 may be, for example, a grinder. A detailed description thereof will be given later with reference to FIG. 6C.

The pressurizing tool 170 may pressurize a tightening member. For example, when a portion of the tightening hole of the tightening region is obstructed, the pressurizing tool 170 may pressurize the tightening member that is obstructing the tightening hole to move the position of the tightening member. A detailed description thereof will be given later with reference to FIG. 6D.

The pressurizing tool 170 may pressurize the second tightening member to normally seat the second tightening member on the first tightening member when the second tightening member is not normally seated on the first tightening member. A detailed description thereof will be given later with reference to FIG. 6E.

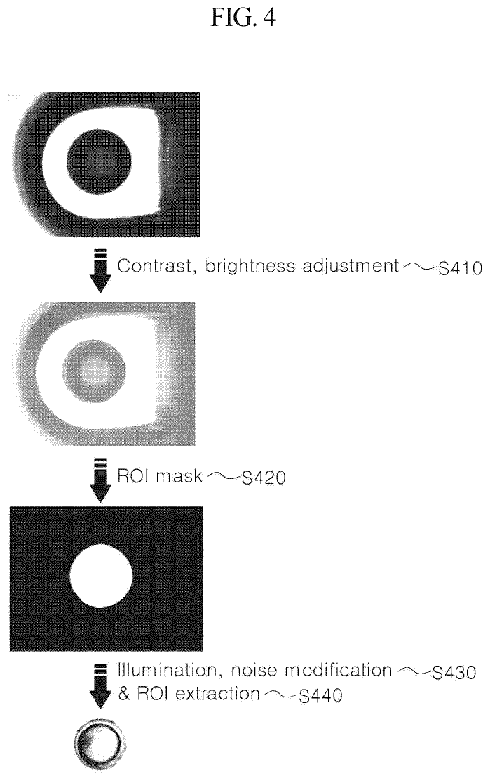

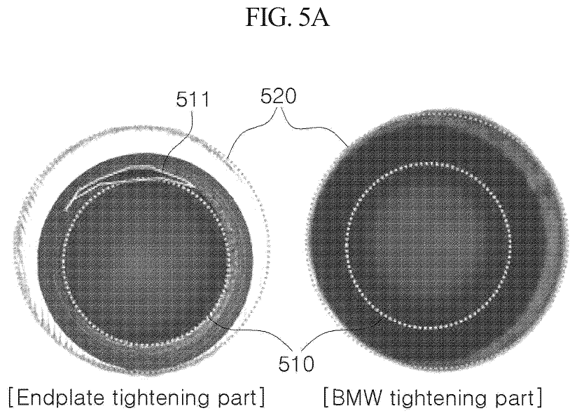

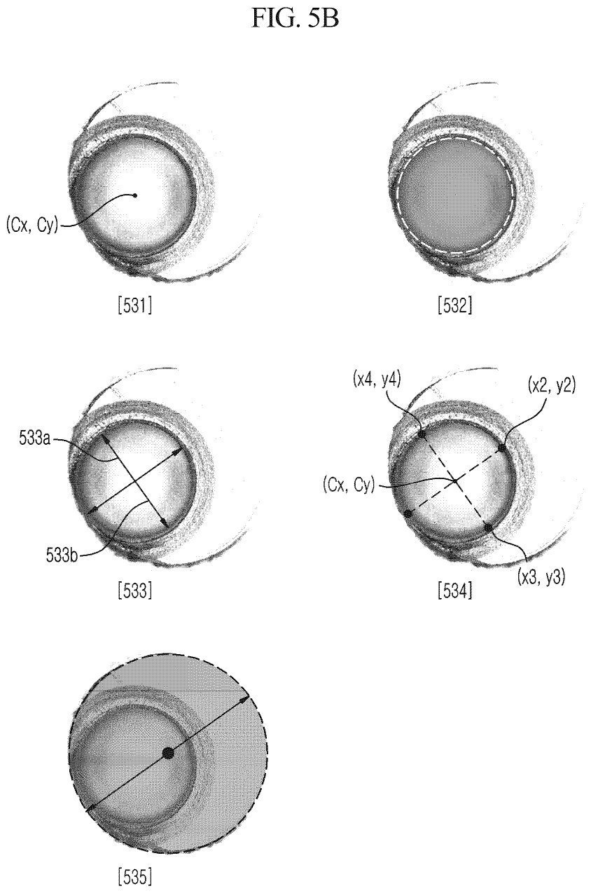

FIG. 3 is a flowchart for describing a control method of the fastener tightening apparatus according to an embodiment of the present disclosure, FIG. 4 is a drawing illustrating an example of preprocessing an image according to an embodiment of the present disclosure, FIG. 5A is a drawing illustrating a tightening region recognized from an image according to an embodiment of the present disclosure, FIG. 5B is a drawing illustrating information about a tightening region estimated from an image according to an embodiment of the present disclosure, FIG. 6A is a drawing illustrating correcting the position of the tightening tool according to an embodiment of the present disclosure, FIG. 6B is a drawing illustrating correcting the tilting angle of the tightening tool according to an embodiment of the present disclosure, FIG. 6C is a drawing illustrating correcting the tightening hole using the machining tool according to an embodiment of the present disclosure, FIG. 6D is a drawing illustrating correcting the position of the tightening member using the pressurizing tool according to an embodiment of the present disclosure, and FIG. 6E is a drawing illustrating correcting the seating state of the tightening member using the pressurizing tool according to an embodiment of the present disclosure.

Referring to FIGS. 3 to 6E, a control method of the fastener tightening apparatus (hereinafter, referred to as a “control method”) according to an embodiment of the present disclosure may include an operation of capturing an image related to a tightening region (S310). For example, the fastener tightening apparatus 100 may, using the camera 130, capture an image related to the tightening region where the fastener is to be tightened. In another embodiment, the fastener tightening apparatus 100 may move the camera 130 to a position above the tightening region and then capture an image of the tightening region.

The tightening region may include at least two components that are tightened via a fastener among the components of a battery module (or a battery pack) (e.g., an upper case, a lower case, a busbar, an endplate, etc.). The tightening region may include at least one tightening hole through which the fastener passes.

The control method of the fastener tightening apparatus according to an embodiment of the present disclosure may include an operation of preprocessing the captured image (S320). For example, the fastener tightening apparatus 100 may, using a pre-trained artificial intelligence model 112 (or an image processing program), preprocess the captured image into a form suitable for analysis by the artificial intelligence model 112. When an artificial intelligence model is used for preprocessing, it may be pre-trained on a dataset comprising pairs of images. For example, each pair may include a low-quality source image (e.g., an image with noise, poor illumination, or low contrast) and a corresponding high-quality target image. The model is then trained to transform the low-quality image into an output that closely matches the high-quality target image, thereby enhancing the image for the subsequent analysis step. The preprocessing operation (S320) may include, as shown in FIG. 4, an operation of adjusting contrast and/or brightness (S410), an operation of masking a Region Of Interest (ROI) (S420), an operation of modifying illumination and/or noise (S430), and an operation of extracting the ROI (S440). This is an embodiment, and it will be apparent to those skilled in the art that the embodiments are not limited thereto. The operation S320 is for improving the recognition performance of the artificial intelligence model 112 for the captured image, and may be omitted when there is no need to improve the recognition performance of the artificial intelligence model 112 (e.g., when the quality of the captured image is suitable for analysis by the artificial intelligence model 112).

The control method of the fastener tightening apparatus according to an embodiment of the present disclosure may include an operation of estimating information about the tightening region from the preprocessed (or captured) image using the artificial intelligence model (S330). For example, the fastener tightening apparatus 100 may analyze the preprocessed (or captured) image, recognize the tightening region, and estimate the information about the tightening region. According to an embodiment of the present disclosure, by using the artificial intelligence model 112, the accuracy of recognition and information estimation of the tightening region can be improved even when a low-quality image is acquired due to various factors (e.g., brightness, focus, shape of a thread, diffuse reflection, shape of a tap, etc.).

The tightening region may, as shown in FIG. 5A, include a first tightening hole 510 (e.g., a bolt hole) associated with a first tightening member (e.g., one of the components of the battery module) and a second tightening hole 520 (e.g., a case hole) associated with a second tightening member (e.g., a case). At this time, in the first tightening hole 510 including a thread 511, a boundary of the hole may be recognized along the thread 511.

The information about the tightening region may include first information related to the first tightening hole 510 and second information related to the second tightening hole 520. The first information may include center point coordinates (Cx, Cy) of the first tightening hole (see reference numeral 531 in FIG. 5B), an area of the first tightening hole (see reference numeral 532 in FIG. 5B), a minimum diameter 533a and a maximum diameter 533b of the first tightening hole (see reference numeral 533 in FIG. 5B), and coordinates of each endpoint of the minimum diameter ((x1, y1), (x2, y2)) and coordinates of each endpoint of the maximum diameter ((x3, y3), (x4, y4)) of the first tightening hole (see reference numeral 534 in FIG. 5B). The second information may include a center position and a diameter of the second tightening hole (see reference numeral 535 in FIG. 5B).

The first information may be used to check (or determine) an obstruction ratio, an obstruction direction, and an obstruction trend of the first tightening hole.

According to an embodiment, the obstruction ratio of the first tightening hole 510 may be determined based on the recognized area, through the below Equation 1.

$$Obstruction Ratio ( \% ) = \frac{( {Area}_{h} - {Area}_{bolt} )}{{Area}_{bolt}} \times 100 \% \qquad < Equation 1 >$$

$$\{ \begin{matrix}Pass , Obstruction Ratio \geq 0 \% \\ Fail , Obstruction Ratio < 0 \%\end{matrix}$$

In Equation 1, “Areaₕ” refers to the area of the first tightening hole recognized from the image, and “Area_{bolt}” refers to the actual area (cross-sectional area) of the bolt. That is, the fastener tightening apparatus 100 may determine that the first tightening hole is not obstructed when the recognized area is greater than or equal to the actual area, and may determine that a portion of the first tightening hole is obstructed by another component (e.g., a case) when the recognized area is smaller than the actual area.

According to another embodiment, the obstruction ratio of the first tightening hole 510 may also be determined through Equation 2.

$$Obstruction Ratio ( \% ) = \frac{( {d}_{h} - {d}_{bolt} )}{{d}_{bolt}} \times 100 \% \qquad < Equation 2 >$$

$$\{ \begin{matrix}Pass , Obstruction Ratio \geq 0 \% \\ Fail , Obstruction Ratio < 0 \%\end{matrix}$$

In Equation 2, “dₕ” refers to the recognized minimum diameter 533a, and “d_{bolt}” refers to the actual minimum diameter of the bolt. In other words, the fastener tightening apparatus 100 may determine that the first fastening hole is not obstructed when the recognized minimum diameter 533a is greater than or equal to the actual minimum diameter. Conversely, the fastener tightening apparatus 100 may determine that a portion of the first fastening hole is obstructed by another component (e.g., a case) when the recognized minimum diameter 533a is less than the actual minimum diameter.

According to an embodiment, the obstruction direction of the first tightening hole may be checked based on a first direction vector (\vec{v1}) and a second direction vector (\vec{v2}), which are calculated through <Equation 3> and <Equation 4> below, based on the coordinates of the center point and each endpoint of the minimum diameter.

$$\vec{v 1} = ( x 1 , y 1 ) - ( Cx , Cy ) \qquad < Equation 3 >$$

$$\vec{v 2} = ( x 2 , y 2 ) - ( Cx , Cy ) \qquad < Equation 4 >$$

The first direction vector (\vec{v1}) in Equation 3 represents a vector from the center point coordinates (Cx, Cy) to one endpoint coordinates (x₁, y₁), and the second direction vector (\vec{v2}) in Equation 4 represents a vector from the center point coordinates (Cx, Cy) to the opposite endpoint coordinates (x₂, y₂). The fastener tightening apparatus 100 may compare the absolute values of the first direction vector (\vec{v1}) and the second direction vector (\vec{v2}), and determine that the obstruction of the first tightening hole 510 has occurred in the direction having the smaller absolute value. For example, in a state as shown in the diagram labeled with reference numeral 534 of FIG. 5B, when the absolute value of the first direction vector (\vec{v1}) is less than that of the second direction vector (\vec{v2}), the fastener tightening apparatus 100 may determine that the obstruction has occurred at the lower left side.

The second information may be used to determine a seating state between the first tightening member 201 and the second tightening member 202. For example, when the second tightening member 202 is not seated (closely attached) in parallel with the first tightening member 201 and is instead seated at a certain inclination angle, the second tightening hole 520 of the second tightening member 202 may be recognized as an ellipse. Utilizing this characteristic, the fastener tightening apparatus 100 may determine that the second tightening member 202 is inclined when the second tightening hole 520 is recognized as an ellipse, and may calculate a tilt angle of the second tightening member 202 using Equation 5 below.

$${θ}_{case} = {cos}^{- 1} ( \frac{{D}_{case}}{{D}_{standard}} ) \qquad < Equation 5 >$$

In Equation 5, “D_{case}” refers to the actual diameter of the second tightening hole 520, “D_{standard}” refers to the recognized maximum diameter of the second tightening hole 520 (i.e., the major axis length of the ellipse), and “θ_{case}” refers to the tilt angle.

The control method of the fastener tightening apparatus according to an embodiment of the present disclosure may include an operation S340 of determining whether a specified reference tightening condition is satisfied based on the estimated information. For example, the fastener tightening apparatus 100 may determine whether the following conditions are satisfied: (i) the seating state between tightening members (e.g., the first tightening member and the second tightening member); (ii) whether the first tightening hole is obstructed; and (iii) whether the difference between the central axis of the first tightening hole and the central axis of the tightening tool is within a predetermined reference value. According to an embodiment, the fastener tightening apparatus 100 may determine that the reference tightening condition is satisfied when the seating state between the tightening members is good (e.g., closely attached), the first tightening hole is not obstructed by another component, and the difference between the central axis of the first tightening hole and the central axis of the tightening tool 140 is within a specified reference value (e.g., 0.3 mm).

The control method of the fastener tightening apparatus according to an embodiment of the present disclosure may proceed to operation S370 of tightening the fastener in the tightening region, in response to a determination in operation S340 that the specified reference tightening condition is satisfied. A detailed description of operation S370 will be provided later.

On the other hand, in response to a determination in operation S340 that the specified reference tightening condition is not satisfied, the control method of the fastener tightening apparatus according to an embodiment of the present disclosure may proceed to operation S350 of determining whether a correction can be made to satisfy the reference tightening condition. For example, the fastener tightening apparatus 100 may determine whether the reference tightening condition can be satisfied by correcting at least one of the second tightening member and the tightening tool 140, with respect to their position and/or state.

In response to a determination in operation S350 that a correction is possible, the control method may proceed to operation S360 of performing the correction. According to an embodiment, the fastener tightening apparatus 100 may correct at least one of the position of the tightening tool 140, the tightening angle, the position of the second tightening member, the seating state of the second tightening member, and the size of the second tightening hole.

In one embodiment, as illustrated in FIG. 6A, when a difference between the center coordinate 601 of the first tightening hole 510 and the center coordinate 602 of the tightening tool exceeds a specified reference value (e.g., 0.3 mm), the fastener tightening apparatus 100 may correct (e.g., move) the position of the tightening tool such that the difference becomes equal to or less than the reference value. For instance, the fastener tightening apparatus 100 may move the position of the tightening tool by a value equal to the difference between the center coordinate 601 (Cx, Cy) of the first tightening hole 510 and the center coordinate 602 (x, y) of the tightening tool, i.e., (Δx=Cx−x, Δy=Cy−y).

In another embodiment, as illustrated in FIG. 6B, when the second tightening member obstructs a portion of the first tightening hole 510, the fastener tightening apparatus 100 may tilt the tightening tool by a calculated tightening angle (θₜᵢₗₜ) to tighten the fastener in the tightening region. The tightening angle may be calculated based on the thickness (T) of the second tightening member 202 (e.g., a case) and the obstruction length (L) of the second tightening member 202 obstructing the first tightening hole 510, using Equation 6 below:

$${θ}_{tilt} = 90 ° - {tan}^{- 1} ( \frac{T}{L} ) \qquad < Equation 6 >$$

The obstruction length (L) in Equation 6 may be calculated as the difference between the actual radius (rₕₒₗₑ) of the first tightening hole and the length of the first direction vector (\vec{v1}), as shown in Equation 7 below:

$$L = {r}_{hole} - \vert \vec{v 1} \vert \qquad < Equation 7 >$$

In another embodiment, as illustrated in FIG. 6C, when the second tightening member 202 obstructs a portion of the first tightening hole 510, the fastener tightening apparatus 100 may use a machining tool 160 (e.g., a grinder) to remove the second tightening member 202 by the obstruction length (L).

In another embodiment, as illustrated in FIG. 6D, when the second tightening member 202 obstructs a portion of the first tightening hole 510, the fastener tightening apparatus 100 may use a pressurizing tool 170 to move the second tightening member 202 in the obstruction direction (or the direction of the first direction vector \vec{v1}) by the obstruction length (L).

In another embodiment, as illustrated in FIG. 6E, when the second tightening member 202 is seated at an inclination angle (θ_{case}) with respect to the first tightening member 201, the fastener tightening apparatus 100 may use the pressurizing tool 170 to press the second tightening member 202 toward the first tightening member 201, thereby allowing the second tightening member 202 to be seated in parallel with the first tightening member 201 (e.g., closely attached).

Once the correction is completed, the control method may perform operation S370 of tightening the fastener in the tightening region. The fastener tightening apparatus 100 may tighten the fastener in the tightening region by, for example, rotating the tightening module 140.

Moreover, when it is determined in operation S350 that the correction is not possible, the control method may proceed to operation S380 of generating an alarm. For example, the fastener tightening apparatus 100 may output a designated sound through an acoustic output device (not shown), continuously emit light of a designated color through an optical output device (not shown), or emit light in a specified pattern (e.g., blinking). Alternatively, the fastener tightening apparatus 100 may transmit a message indicating that tightening of the fastener is not possible to a designated electronic device (e.g., a management PC, or an administrator's smartphone).

Although not illustrated, the control method may further include an operation of recognizing an obstruction trend based on the obstruction directions of the plurality of first tightening holes when the first tightening member includes a plurality of first tightening holes, and generating an alarm indicating that an adjustment of the second tightening member is required based on the recognized obstruction trend. For example, when obstructions are frequently detected in the lower-left direction, the fastener tightening apparatus 100 may recognize the lower-left direction as an obstruction trend. In such a case, the fastener tightening apparatus 100 may determine that the second tightening member covering the first tightening holes is misaligned toward the upper-right direction, and generate an alarm (e.g., notify the administrator) to adjust the misalignment of the second tightening member (e.g., by moving the second tightening member toward the lower-left direction). Such an alarm based on obstruction trend may be useful for responding to LOT-specific errors that may occur due to manufacturing tolerances varying by production batch. That is, the embodiments of the present disclosure may reduce the frequency of errors and/or corrections by appropriately adjusting the placement of the second tightening member on a LOT basis. Accordingly, the embodiments may improve production efficiency.

In addition, the control method may further include an operation of generating an alarm indicating that a reset or initialization of the working environment (e.g., jig or datum pin) is required when the correction occurs more than a specified number of times. It is apparent to those skilled in the art that the various correction and alarm embodiments described above may be used individually or in combination of at least two.

The above description is illustrative of embodiments applying the principles of the present disclosure, and other embodiments may be included without departing from the scope of the disclosure. Furthermore, the embodiments may be combined to form additional embodiments.

What is claimed is:

1. An apparatus for tightening a fastener, the apparatus comprising:
a tightening tool configured to engage the fastener and tighten the fastener,
a memory storing an artificial intelligence model;
a camera that captures an image of a tightening region where the fastener is to be tightened; and
a processor operatively coupled to the tightening tool, the memory, and the camera, wherein the processor is programmed to:
estimate, using the artificial intelligence model, information about the tightening region from the image captured by the camera,
determine, based on the estimated information, whether a specified reference tightening condition is satisfied, and
in response to the reference tightening condition being satisfied, control the tightening tool to tighten the fastener in the tightening region.

2. The apparatus of claim 1,
wherein the artificial intelligence model is pre-trained, and
wherein the specified reference tightening condition comprises at least one of:
a seating state between a first tightening member and a second tightening member disposed on the first tightening member,
whether a first tightening hole formed in the first tightening member is obstructed, or
a difference between a central axis of the tightening tool and a central axis of the first tightening hole.

3. The apparatus of claim 2, wherein the processor is further programmed to:
determine whether a correction is possible, in response to the specified reference tightening condition not being satisfied;
correct, in response to a determination that the correction is possible, at least one of a position of the tightening tool, a tightening angle of the fastener, a position of the second tightening member, a seating state of the second tightening member, or a size of a second tightening hole formed in the second tightening member, to satisfy the specified reference tightening condition; and
generate an alarm, in response to a determination that the correction is not possible, indicating that tightening of the fastener in the tightening region is not possible.

4. The apparatus of claim 3, wherein the processor is further programmed to:
move the position of the tightening tool, in response to the difference between the central axis of the tightening tool and the central axis of the first tightening hole exceeding a specified reference value, such that the difference is within the specified reference value.

5. The apparatus of claim 3, wherein the processor is further programmed to, in response to the second tightening member obstructing a portion of the first tightening hole:
calculate a tightening angle based on a thickness of the second tightening member and an obstruction length of the second tightening member obstructing the first tightening hole and
control the tightening tool to tilt by the calculated tightening angle.

6. The apparatus of claim 3,
further comprising a machining tool,
wherein the processor is further programmed to, in response to the second tightening member obstructing a portion of the first tightening hole:
calculate an obstruction length and an obstruction direction of the second tightening member obstructing the first tightening hole; and
control the machining tool to remove a portion of the second tightening member in the obstruction direction by the obstruction length.

7. The apparatus of claim 3,
further comprising a pressurizing tool, wherein the processor is further programmed to, in response to the second tightening member obstructing a portion of the first tightening hole:
calculate an obstruction length and an obstruction direction of the second tightening member obstructing the first tightening hole; and
control the pressurizing tool to move the second tightening member in the obstruction direction by the obstruction length.

8. The apparatus of claim 3,
further comprising a pressurizing tool,
wherein the processor is further programmed to, in response to the second tightening member being seated at an incline on the first tightening member:
calculate an angle of the incline of the second tightening member based on an actual diameter of the second tightening hole and a diameter of the second tightening hole calculated from the image; and
control the pressurizing tool to press the second tightening member in a direction toward the first tightening member in correspondence with the calculated angle of the incline.

9. The apparatus of claim 3, wherein the processor is further programmed to, when the first tightening member comprises a plurality of first tightening holes:
recognize an obstruction trend based on obstruction directions for the plurality of first tightening holes; and
generate an alarm, based on the recognized obstruction trend, indicating that an adjustment for the second tightening member is required.

10. The apparatus of claim 3, wherein the processor is further programmed to:
generate an alarm indicating that a reset of a working environment is required, in response to the correction occurring more than or equal to a specified number of times.

11. The apparatus of claim 1,
wherein the tightening tool is a nut runner and the fastener is a screw or a bolt, and
wherein the processor is further programmed to:
preprocess the captured image;
analyze the preprocessed image using the artificial intelligence model;
recognize the tightening region based on a result of the analysis; and
estimate the information about the tightening region based on a result of the recognition.

12. A method for controlling a tightening apparatus, the method comprising:
capturing, using a camera, an image of a tightening region where a fastener is to be tightened;
estimating, using an artificial intelligence model, information about the tightening region from the captured image;
determining based on the estimated information, whether a specified reference tightening condition is satisfied; and
in response to the specified reference tightening condition being satisfied, tightening the fastener in the tightening region using a tightening tool.

13. The method of claim 12, wherein the operation of determining whether the specified reference tightening condition is satisfied comprises:
determining a seating state between a first tightening member and a second tightening member disposed on the first tightening member,
determining whether a first tightening hole formed in the first tightening member is obstructed; and
determining whether a difference between a central axis of the tightening tool and a central axis of the first tightening hole is within a specified reference value.

14. The method of claim 13, the method further comprising:
in response to the specified reference tightening condition not being satisfied, determining whether a correction is possible; and
in response to a determination that the correction is not possible, generating an alarm indicating that tightening of the fastener in the tightening region is not possible,
in response to a determination that the correction is possible, correcting at least one of a position of the tightening tool, a tightening angle of the fastener, a position of the second tightening member, a seating state of the second tightening member, or a size of a second tightening hole formed in the second tightening member.

15. The method of claim 14, wherein the operation of correcting comprises:
in response to a difference between a center coordinate of the first tightening hole and a center coordinate of the tightening tool exceeding a specified reference value, moving the position of the tightening tool such that the difference is within the specified reference value.

16. The method of claim 14, wherein the operation of correcting comprises performing, in response to the second tightening member obstructing a portion of the first tightening hole, at least one of the following:
calculating a tightening angle based on a thickness of the second tightening member and an obstruction length of the second tightening member obstructing the first tightening hole, and tilting the tightening tool by the calculated tightening angle;
calculating an obstruction length and an obstruction direction of the second tightening member obstructing the first tightening hole, and, using a machining tool, removing a portion of the second tightening member in the obstruction direction by the obstruction length; or
calculating an obstruction length and an obstruction direction of the second tightening member obstructing the first tightening hole, and, using a pressurizing tool, moving the second tightening member in the obstruction direction by the obstruction length.

17. The method of claim 14, wherein the operation of correcting comprises, in response to the second tightening member being seated at an incline on the first tightening member:
calculating an angle of the incline of the second tightening member based on an actual diameter of the second tightening hole and a diameter of the second tightening hole calculated from the image; and
in correspondence with the calculated angle of the incline, pressing, using a pressurizing tool, the second tightening member in a direction toward the first tightening member.

18. The method of claim 14, the method further comprising at least one of:
when the first tightening member comprises a plurality of first tightening holes, recognizing an obstruction trend based on obstruction directions for the plurality of first tightening holes and, based on the recognized obstruction trend, generating an alarm indicating that an adjustment for the second tightening member is required; or
generating an alarm indicating that a reset of a working environment is required, in response to the correction occurring more than or equal to a specified number of times.

19. The method of claim 12,
the method further comprising preprocessing the captured image,
wherein the operation of estimating information about the tightening region comprises:
analyzing the preprocessed image using the artificial intelligence model;
recognizing the tightening region based on a result of the analysis; and
estimating the information about the tightening region based on a result of the recognition.

20. An apparatus for tightening a fastener, the apparatus comprising:
a tightening tool configured to engage a fastener and tighten the fastener to a tightening region including at least two components that are tightened via the fastener,
a position/tilting controller operatively coupled to the tightening tool for changing the position, angle, or both of the tightening tool;
a memory storing an artificial intelligence model;
a camera that captures an image of the tightening region where the fastener is to be tightened; and
a processor operatively coupled to the tightening tool, the memory, the camera, and the position/tilting controller
wherein the processor is configured to:
use the artificial intelligence model to estimate information about the tightening region from the image captured by the camera, and
use the information to control the position/tilting controller to change the position, tilt, or both of the tightening tool, and to control the tightening tool to tighten the fastener in the tightening region.
